(19) United States
(12) Patent Application Publication
(10) Pub. No.: US 2019/0138092 A1
(43) Pub. Date: May 9, 2019

(54) DISPLAY APPARATUS

(71) Applicant: Qisda Corporation, Taoyuan City (TW)

(72) Inventor: GUAN-LUN SONG, Taoyuan City (TW)

(73) Assignee: Qisda Corporation, Taoyuan City (TW)

(21) Appl. No.: 16/178,752

(22) Filed: Nov. 2, 2018

(30) Foreign Application Priority Data
Nov. 3, 2017 (CN) 201711067573.6

(51) Int. Cl. G06F 3/01; G09G 3/22; G06T 7/70; G06T 7/11; G06T 7/20

(52) U.S. Cl. CPC G06F 3/013; G09G 3/22; G09G 2320/0626; G06T 7/11; G06T 7/20; G06T 7/70

(57) ABSTRACT

A display apparatus is disclosed. The display apparatus includes at least one display unit and a host. The host is cooperated with the at least one display unit. The host includes a sensing unit. When the at least one display unit displays a frame, the sensing unit is used to sense a first gaze position on the frame which is watched by an eye and a first distance between the eye and the first gaze position. When the display apparatus determines a first gaze range corresponding the first distance and divides the frame into a first gaze region and a first non-gaze region according the first gaze position and the first gaze range, the display apparatus changes a display parameter of the first gaze region or the first non-gaze region.

### BACKGROUND OF THE INVENTION

### 1. Field of the Invention

The invention relates to a display apparatus; in particular, to a display apparatus capable of providing eye tracking adaptive function.

### 2. Description of the Prior Art

As the display technology continues to evolve, the size of the display apparatus has become larger and larger, and various wide-screen products have appeared on the market to meet the needs of consumers.

However, not all display applications require the entire display area of the display apparatus to be used. In general, only a portion of the display area will be used in many cases. For example, when a user reads a webpage or edits a file through a display apparatus, only a part of the display area of the display apparatus is often used, but an ordinary display apparatus still provides the same backlight brightness to the remaining unused display areas, thus causing unnecessary energy consumption.

### SUMMARY OF THE INVENTION

Therefore, the invention provides to solve the above-mentioned problems of the prior arts.

A preferred embodiment of the invention is a display apparatus. In this embodiment, the display apparatus includes at least one display unit and a host. The host is cooperated with the at least one display unit. The host includes a sensing unit. When the at least one display unit displays a frame, the sensing unit is used to sense a first gaze position on the frame which is gazed by an eye and a first distance between the eye and the first gaze position. When the display apparatus determines a first gaze range corresponding the first distance and divides the frame into a first gaze region and a first non-gaze region according the first gaze position and the first gaze range, the display apparatus changes a display parameter of the first gaze region or the first non-gaze region. When the distance between the eye and the first gaze position is changed from the first distance to a first changed distance, the display apparatus determines whether the first distance and the first changed distance are within the same distance interval. If a determination result of the display apparatus is YES, the display apparatus maintains the first gaze range unchanged. If the determination result of the display apparatus is NO, the display apparatus determines a corresponding first change gaze range according to the first changed distance, and divides the frame into a first changed gaze region and a first changed non-gaze region according to the first gaze position and the first changed gaze range and changes display parameters of the first changed gaze region or the first changed non-gaze region.

In an embodiment, when the display apparatus changes the display parameter of the first gaze region or the first non-gaze region, the contrast between the first gaze region and the first non-gaze region increases.

In an embodiment, the display apparatus reduces backlight brightness corresponding to the first non-gaze region.

In an embodiment, the display apparatus reduces resolution corresponding to the first non-gaze region.

In an embodiment, the display apparatus reduces the resolution of displaying the first non-gazing region through the at least one display unit or reduces the resolution of the first non-gazing region through the host and then outputs the frame to the at least one display unit to display the frame.

In an embodiment, the sensing unit of the host senses the first gaze position and the first distance through eyeball tracking technology.

In an embodiment, the first gaze range has a gaze radius and there is a proportional relationship between the gaze radius and the first distance.

Another preferred embodiment of the invention is a display apparatus. In this embodiment, the display apparatus includes a first display unit, a second display unit and a host. The host is cooperated with the first display unit and the second display unit. The host includes a sensing unit. When the first display unit and the second display unit display a frame, the sensing unit is used to sense a gaze position on the frame which is gazed by an eye and a distance between the eye and the gaze position. If the gaze position is located on the first display unit, the display apparatus determines a gaze range on the first display unit corresponding the distance, divides the frame into a gaze region on the first display unit and a non-gaze region on the first display unit and the second display unit according the gaze position and the gaze range, and changes a display parameter of the gaze region on the first display unit or the non-gaze region on the first display unit and the second display unit to improve a contrast between the gaze region on the first display unit and the non-gaze region on the first display unit and the second display unit.

Compared to the prior art, the display apparatus of the present invention is a smart display capable of providing an eye tracking adaptive function, which obtains a gaze position on the display apparatus when a human eye gazes the frame displayed by the display apparatus and a distance between the human eye and the gaze position through eyeball tracking technology, and then determines corresponding gaze range and divides the frame into a gaze region and a non-gaze region according to the gaze position and the gaze range. Afterward, the effects of saving power, improving information security or enhancing user's visual experience can be achieved by changing the display parameters of the gaze region or the non-gaze region.

The advantage and spirit of the invention may be understood by the following detailed descriptions together with the appended drawings.

### BRIEF DESCRIPTION OF THE APPENDED DRAWINGS

FIG. 1 illustrates a schematic diagram of the display apparatus 1 including one display unit in an embodiment of the invention.

FIG. 2A illustrates a schematic diagram of the first gaze position P1 gazed by the eye E on the frame F displayed by the display unit D1 in FIG. 1 and the first distance N1 between the eye E and the first gaze position P1.

FIG. 2B illustrates a schematic diagram of the proportional relationship between the gaze radius r of the first gaze range R1 and the first distance N1 in FIG. 2A.

FIG. 2C illustrates a schematic diagram of dividing the frame F into the first gaze region F1 and the first non-gaze region F2 through the first gaze range R1 obtained according to the first gaze position P1 and the first distance N1.

FIG. 2D illustrates a schematic diagram of reducing the resolution corresponding to the first non-gaze region F2.

FIG. 3 illustrates a schematic diagram of the display apparatus 3 including a plurality of display units in another embodiment of the invention.

FIG. 4A illustrates a schematic diagram of the second gaze position P2 gazed by the eye E on the frame F′ displayed by the first display unit D1 and the second display unit D2 in FIG. 3 and the second distance N2 between the eye E and the second gaze position P2.

FIG. 4B illustrates a schematic diagram of dividing the frame F′ into the second gaze region F3 and the second non-gaze region F4 through the second gaze range R2 obtained according to the second gaze position P2 and the second distance N2.

FIG. 4C illustrates a schematic diagram of reducing the backlight brightness corresponding to the second non-gaze region F4.

FIG. 4D illustrates a schematic diagram of reducing the backlight brightness corresponding to the third non-gaze region F6.

FIG. 5 illustrates a flowchart of the display apparatus operating method in another embodiment of the invention.

### DETAILED DESCRIPTION OF THE INVENTION

A preferred embodiment of the invention is a display apparatus. In this embodiment, the display apparatus can be a smart display capable of providing an eye tracking adaptive function and the display apparatus can include at least one display unit which can be any display with image displaying function without specific limitations.

Please refer to FIG. 1. FIG. 1 illustrates a schematic diagram of the display apparatus 1 including one display unit (e.g., a first display unit D1) in an embodiment of the invention.

As shown in FIG. 1, the display apparatus 1 includes a first display unit D1 and a host H, and the host H operates in cooperation with the first display unit D1. The host H can be wirelessly or wiredly coupled to the first display unit D1. The host H can include a sensing unit S and a processor C. The sensing unit S is coupled to the processor C. The first display unit D1 includes a scaler L and a display panel M. The scaler L is coupled to the display panel M and the processor C. When the display panel M of the first display unit D1 displays the frame F, the host H can sense a first gaze position P1 on the frame F which is gazed by an eye E of the user and a first distance N1 between the eye E of the user and the first gaze position P1 through the sensing unit S. And then, the host H transmits the sensed first gaze position P1 and the first distance N1 to the processor C.

In practical applications, the sensing unit S can track the movement of the user's eye E through the eye tracking technology to obtain the first gaze position P1 on the frame F which is gazed by the eye E of the user and then further estimate the first distance N1 between the user's eye E and the first gaze position P1, but not limited to this.

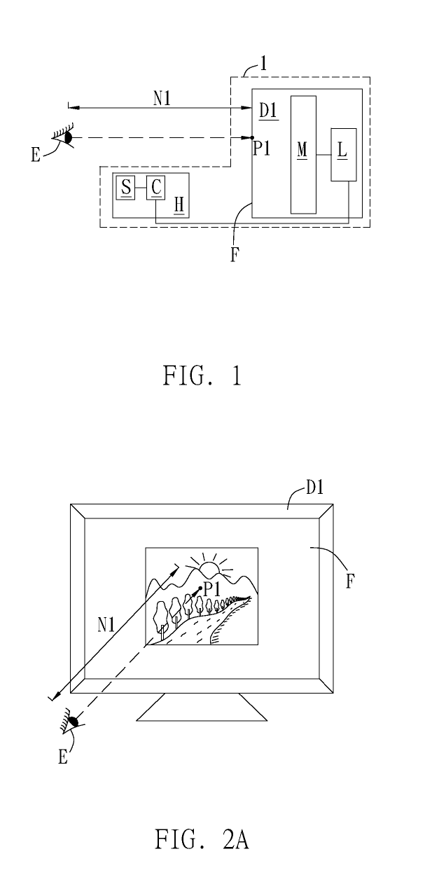

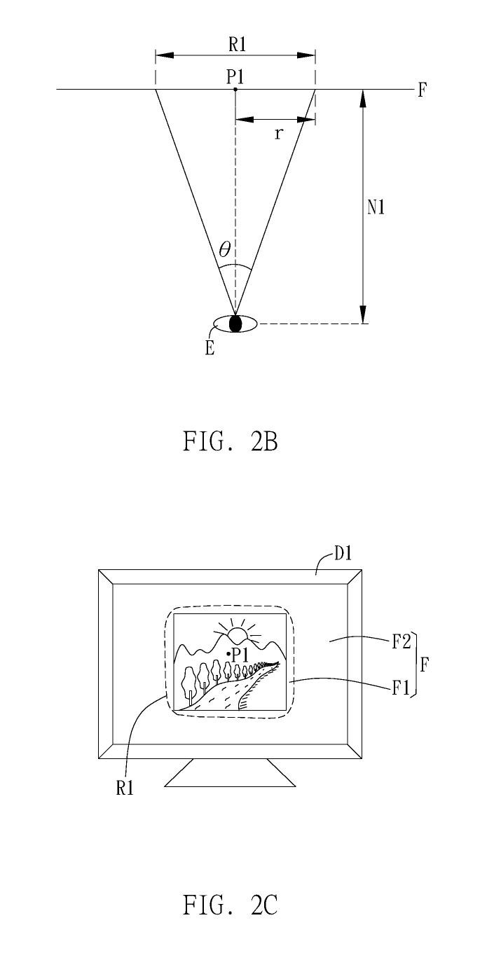

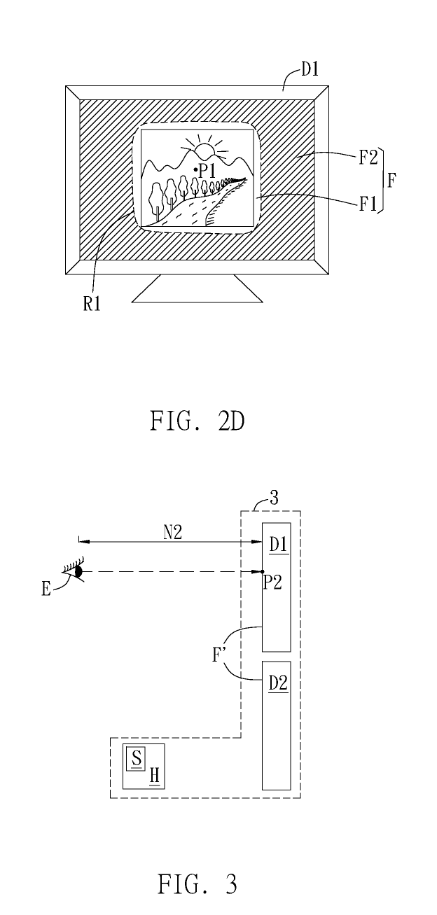

Please also refer to FIG. 2A and FIG. 2B. FIG. 2A illustrates a schematic diagram of the first gaze position P1 gazed by the eye E on the frame F displayed by the display unit D1 in FIG. 1 and the first distance N1 between the eye E and the first gaze position P1; FIG. 2B illustrates a schematic diagram of the proportional relationship between the gaze radius r of the first gaze range R1 and the first distance N1 in FIG. 2A. In this embodiment, the center of the frame F displayed by the first display unit D1 is a landscape photo, and the user's eye E gazes the landscape photo, but not limited to this.

After the host H senses the first gaze location P1 and the first distance N1 through the sensing unit S and transmits the first gaze location P1 and the first distance N1 to the processor C, the processor C can select to transmit the first distance N1 to the scaler L of the first display unit D1 and the scaler L of the first display unit D1 determines a corresponding first gaze range R1 according to the first distance N1, or the processor C can determine the corresponding first gaze range R1 according to the first distance N1 and then transmit the first gaze range R1 to the scaler L of the first display unit D1.

In practical applications, the shape or size of the first gaze range R1 is not particularly limited and can be determined according to practical needs. In an embodiment, the first gaze range R1 can have a gaze radius and the gaze radius can have a proportional relationship with the first distance N1, but is not limited to this.

For example, as shown in FIG. 2B, it is assumed that the first distance between the user's eye E and the first gaze position P1 on the frame F is N1, and a gaze angle range of the user's eye E is θ, then the gaze radius r of the corresponding first gaze range R1 can be equal to N1*tan(θ/2), but is not limited to this. In fact, since the gaze angle range θ of the eye E of the user is generally about 20°; that is to say, the gaze angle ranges at both sides of the line connecting the user's eye E and the first gaze position P1 on the frame F are about 10°. Therefore, the corresponding gaze radius r is approximately equal to N1*tan 10°, but in fact, it can still be customized according to the user's visual experience to meet the needs of different users, and it is not limited to this.

Next, as shown in FIG. 2C, the processor C can divide the frame F into a first gaze region F1 and a first non-gaze region F2 according to the first gaze position P1 and the first gaze range R1 and change the display parameter of the first gaze region F1 or the first non-gaze region F2 in the frame F, and then transmit it to the first display unit D1 for displaying, or the scaler L of the first display unit D1 change the display parameter of the first gaze region F1 or the first non-gaze region F2 in the frame F and then transmit it to the display panel M for displaying.

For example, as shown in FIG. 2D, the display apparatus 1 can select the processor C to reduce the resolution of the first non-gaze region F2 in the frame F and then transmit it to the first display unit D1 for displaying, or the display apparatus 1 can select the scaler L of the display unit D1 to reduce the resolution of the first non-gaze region F2 in the frame F and then transmits it to the display panel M for displaying, so that in the frame F displayed by the display panel M of the first display unit D1, only the first gaze region F1 gazed by the eye E of the user maintains sharpness and the first non-gaze region F2 not gazed by the eye E of the user becomes blurred to achieve the effect of improving information security.

In addition, if the original resolution of the frame F is not high enough, the display apparatus 1 can select the processor C to increase the resolution of the first gaze region F1 of the frame F and to maintain or reduce the resolution of the first non-gaze region F2 in the frame F and then output it to the first display unit D1 for displaying, or the display apparatus 1 can select the scaler L of the first display unit D1 to increase the resolution of the first gaze region F1 of the frame F and to maintain or reduce the resolution of the first non-gaze region F2 in the frame F and then transmit it to the display panel M for displaying, so that the user can see more clearly, but not limited to this.

It should be noted that since the distance between the user's eye E and the first gaze position P1 will be changed due to the adjustment of the user's posture or position, for example, the original first distance N1 is changed to the first changed distance, then the sensing unit S of the host H can measure the first changed distance and the processor C can determine whether the first changed distance is within the same distance interval as the first distance N1. In practical applications, the range of the distance interval can be a system default value or set by the user without specific restrictions.

If the result of the above determination is YES, that is to say, the first changed distance is within the same distance interval as the first distance N1, it means that the distance between the eye E of the user and the first gaze position P1 does not change much, and the user should only slightly adjust his posture or position, the original first gaze range R1 is still maintained, so as to avoid the user's visual discomfort caused by the excessively frequent change of the first gaze range R1.

If the result of the above determination is NO, that is to say, the first changed distance is not in the same distance range as the first distance N1, it means that the distance between the eye E of the user and the first gaze position P1 changes greatly, so that the processor C or the scaler L of the first display unit D1 will re-determine a corresponding first changed gaze range according to the first changed distance and divide the frame F into a first changed gaze region and a first changed non-gaze region according to the first gaze position P1 and the first changed gaze range. And then, the processor C or the scaler L of the first display unit D1 will change the display parameter of the first changed gaze region or the first changed non-gaze region.

Similarly, if the first gaze position P1 on the frame F gazed by the user's eye E only changes slightly, it can be considered that the user only slightly adjusts his posture or position, so that the original first gaze range R1 remains unchanged, so as to avoid the user's visual discomfort caused by the excessively frequent change of the first gaze range R1.

Please refer to FIG. 3. FIG. 3 illustrates a schematic diagram of the display apparatus 3 including a plurality of display units (e.g., a first display unit D1 and a second display unit D2) in another embodiment of the invention. It should be noted that, for the sake of brevity, FIG. 3 does not show that the display apparatus 3 includes components such as the processor C, the scaler L and the display panel M in FIG. 1, but the display apparatus 3 can actually include the above components. For the operation of the above components, reference may be made to the related description of the above components, and details are not described herein.

As shown in FIG. 3, the display apparatus 3 includes a first display unit D1, a second display unit D2, and a host H, and the host H operates in cooperation with the first display unit D1 and the second display unit D2. The host H can be wirelessly or wiredly coupled to the first display unit D1 and the second display unit D2 respectively. The host H includes a sensing unit S. The first display unit D1 and the second display unit D2 can provide a video wall function to display the same frame together.

When the first display unit D1 and the second display unit D2 display the same frame F′ together, the host H can sense a second gaze position P2 on the frame F′ gazed by the user's eye E and a second distance N2 between the user's eye E and the second gaze position P2 through the sensing unit S. In practical applications, the sensing unit S can measure the second gaze position P2 and the second distance N2 through the eyeball tracking technology, but not limited to this.

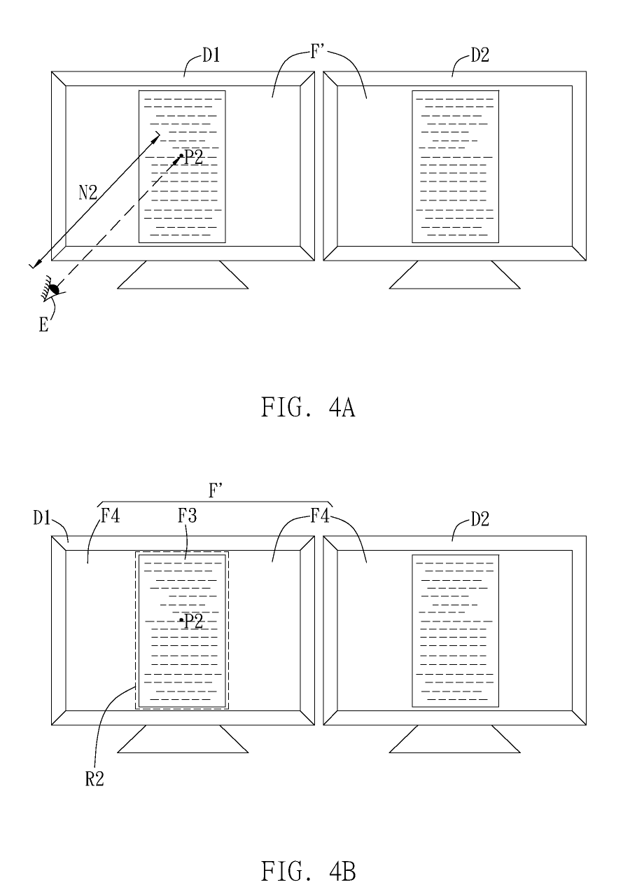

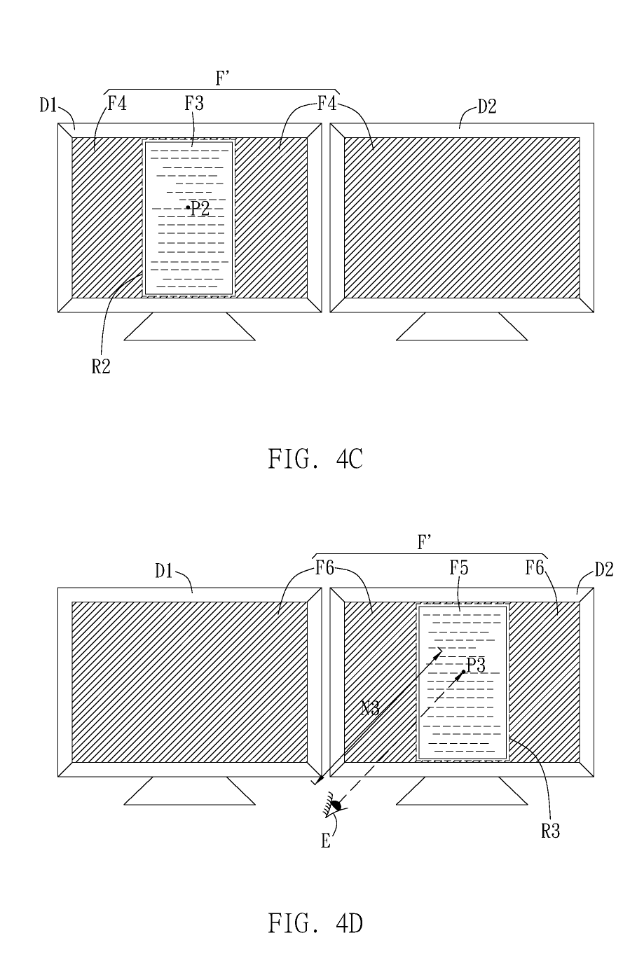

Please also refer to FIG. 4A. FIG. 4A illustrates a schematic diagram of the second gaze position P2 gazed by the eye E on the frame F′ displayed by the first display unit D1 and the second display unit D2 in FIG. 3 and the second distance N2 between the eye E and the second gaze position P2. In this embodiment, although the first display unit D1 and the second display unit D2 display different files respectively, since the user's eye E gazes the file displayed by the first display unit D1, the second gaze position P2 should be located on the first display unit D1 instead of the second display unit D2, but not limited to this.

After the host H senses the second gaze position P2 and the second distance N2 through the sensing unit S, the host H can select to transmit the second distance N2 to the first display unit D1 and the first display unit D1 will determine the corresponding second gaze range R2 according to the second distance N2, or the host H determines the corresponding second gaze range R2 according to the second distance N2 and then transmits the second gaze range R2 to the first display unit D1. In practical applications, the second gaze range R2 can have a gaze radius and there is a proportional relationship between the gaze radius and the second distance N2, but not limited to this.

Next, as shown in FIG. 4B, the first display unit D1 and the second display unit D2 displaying the same frame F′ will divide the frame F′ into the second gaze region F3 and the second non-gaze region F4 according to the second gaze position P2 and the second gaze range R2. Then, the first display unit D1 and the second display unit D2 will change display parameters of the second gaze region F3 and the second non-gaze region F4 to improve the contrast between the second gaze region F3 and the second non-gaze region F4.

For example, as shown in FIG. 4C, the first display unit D1 and the second display unit D2 can reduce the backlight brightness of the second non-gaze region F4, such that in the frame F′ displayed by the first display unit D1 and the second display unit D2 together, only the second gaze region F3 gazed by the user's eye E maintains the original brightness and the second non-gaze region F4 not gazed by the user's eye E becomes dark to achieve power saving effect. In addition, if the brightness of the frame F′ displayed by the first display unit D1 and the second display unit D2 together is already dark, in order to enable the second gaze region F3 to be displayed more clearly for the convenience of the user, the first display unit D1 can also increase the backlight brightness of the second gaze region F3, but not limited to this. That is to say, the invention improves the contrast between the second gaze region F3 and the second non-gaze region F4 by making the display parameters of the second gaze region F3 and the second non-gaze region F4 different. Moreover, in addition to changing the brightness parameter, other display parameters of the second attention region F3 and/or the second non-gaze region F4, such as contrast, resolution, color saturation, etc., can be also changed; In addition, one display parameter or a plurality of display parameters can be adjusted to improve the contrast between the second gaze region F3 and the second non-gaze region F4.

It should be noted that the second gaze region F3 can be only displayed on the first display unit D1 or the second display unit D2, but not limited to this. In this embodiment, the second gaze region F3 is only located on the first display unit D1, and the second non-gaze area F4 can be located on the first display unit D1 and the second display unit D2 at the same time. In other embodiments, the first display unit D1 and the second display unit D2 can have the second gaze region F3 respectively, for example, a plurality of users views the first display unit D1 and the second display unit D2 respectively.

In addition, as shown in FIG. 4D, if the user's eye E begins to view the file displayed by the second display unit D2 after viewing the file displayed by the first display unit D1, the host H will sense a third gaze position P3 on the frame F′ gazed by the user's eye E and a third distance N3 between the user's eye E and the third gaze position P3 through the sensing unit S.

Then, the host H can select to transmit the third distance N3 to the second display unit D2 and the second display unit D2 can determine the corresponding third gaze range R3 according to the third distance N3, or the host H can determine the corresponding third gaze range R3 according to the third distance N3 and then transmit the third gaze range R3 to the second display unit D2. The first display unit D1 and the second display unit D2 displaying the frame F′ together will divide the frame F′ into a third gaze region F5 and a third non-gaze region F6 according to the third gaze position P3 and the third gaze range R3. Wherein, the manner in which the third gaze region F5 and the third non-gaze region F6 are disposed in different embodiments can be the same as the second gaze region F3 and the second non-gaze region F4, and details are not described herein.

Then, the second display unit D2 changes the display parameters of the third gaze region F5 and the third non-gaze region F6. For example, the second display unit D2 can reduce the backlight brightness of the third non-gaze region F6, so that in the frame F′ displayed by the first display unit D1 and the second display unit D2 together, only the third gaze region F5 maintains original brightness, and the remaining third non-gaze region F6 becomes dark to achieve power saving effect.

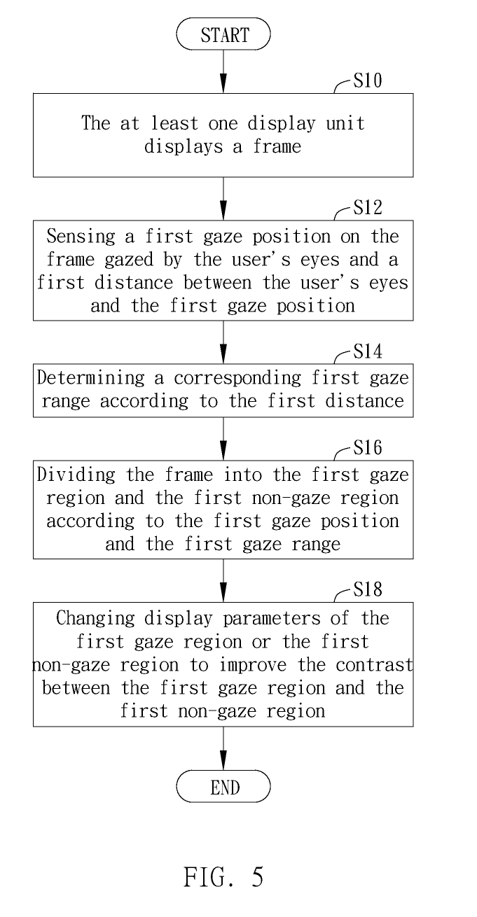

Another embodiment of the invention is a method of operating a display apparatus. In this embodiment, the display apparatus operating method is used to operate the display apparatus. The display apparatus includes at least one display unit. Next, please refer to FIG. 5. FIG. 5 illustrates a flowchart showing the display apparatus operating method in this embodiment.

As shown in FIG. 5, the display apparatus operating method can include following steps:

Step S10: the at least one display unit displays a frame;

Step S12: sensing a first gaze position on the frame gazed by the user's eyes and a first distance between the user's eyes and the first gaze position;

Step S14: determining a corresponding first gaze range according to the first distance;

Step S16: dividing the frame into the first gaze region and the first non-gaze region according to the first gaze position and the first gaze range; and

Step S18: changing display parameters of the first gaze region or the first non-gaze region to improve the contrast between the first gaze region and the first non-gaze region.

In practical applications, in the step S12, the first gaze position and the first distance are measured by the host using the eyeball tracking technology, but not limited to this. When the host senses the first distance, the host can transmit the first distance to the at least one display unit, and in the step S14, the at least one display unit can determine the corresponding first gaze range according to the first distance, and the first gaze range can have a gaze radius and there is a proportional relationship between the gaze radius and the first distance, but not limited to this.

In addition, when the host senses the first distance, in the step S14, the host can determine the corresponding first gaze range according to the first distance and then transmit the first gaze range to the at least one display unit. It should be noted that step S18 can achieve the power saving effect by reducing the brightness of the backlight corresponding to the first non-gaze region, or improve the information security by reducing the resolution corresponding to the first non-gaze region, or achieve the effect of improving the visual perception of the user by increasing the resolution or the brightness of the backlight corresponding to the first gaze region, but not limited to this.

When the distance between the eye and the first gaze position is changed from the original first distance to a first changed distance, the display apparatus operating method will further determine whether the first distance and the first changed distance are within the same distance interval. If the result of the above determination is yes, it means that the distance between the eye and the first gaze position does not change much, so that the first gaze range is maintained unchanged to avoid the first gaze range being changed too frequently.

If the result of the above determination is no, it means that the distance between the eye and the first gaze position changes greatly, so that the display apparatus operating method will determine the corresponding first changed gaze range according to the first changed distance, divide the frame into a first changed gaze region and a first changed non-gaze region according to the first gaze position and the first changed gaze range, and change the display parameters of the first changed gaze region or the first changed non-gaze region, thereby achieving the effects of saving power, improving information security, or enhancing the visual experience of the users.

Compared to the prior art, the display apparatus of the present invention is a smart display capable of providing an eye tracking adaptive function, which obtains a gaze position on the display apparatus when a human eye gazes the frame displayed by the display apparatus and a distance between the human eye and the gaze position through eyeball tracking technology, and then determines corresponding gaze range and divides the frame into a gaze region and a non-gaze region according to the gaze position and the gaze range. Afterward, the effects of saving power, improving information security or enhancing user's visual experience can be achieved by changing the display parameters of the gaze region or the non-gaze region.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display apparatus, comprising:
at least one display unit; and
a host, cooperated with the at least one display unit, the host comprising:
a sensing unit, when the at least one display unit displays a frame, the sensing unit sensing a first gaze position on the frame which is gazed by an eye and a first distance between the eye and the first gaze position;
wherein when the display apparatus determines a first gaze range corresponding the first distance and divides the frame into a first gaze region and a first non-gaze region according the first gaze position and the first gaze range, the display apparatus changes a display parameter of the first gaze region or the first non-gaze region, when the distance between the eye and the first gaze position is changed from the first distance to a first changed distance, the display apparatus determines whether the first distance and the first changed distance are within the same distance interval, if a determination result of the display apparatus is YES, the display apparatus maintains the first gaze range unchanged; if the determination result of the display apparatus is NO, the display apparatus determines a corresponding first changed gaze range according to the first changed distance, and divides the frame into a first changed gaze region and a first changed non-gaze region according to the first gaze position and the first changed gaze range and changes display parameters of the first changed gaze region or the first changed non-gaze region.

2. The display apparatus of claim 1, wherein when the display apparatus changes the display parameter of the first gaze region or the first non-gaze region, the contrast between the first gaze region and the first non-gaze region increases.

3. The display apparatus of claim 1, wherein the display apparatus reduces backlight brightness corresponding to the first non-gaze region.

4. The display apparatus of claim 1, wherein the display apparatus reduces resolution corresponding to the first non-gaze region.

5. The display apparatus of claim 4, wherein the display apparatus reduces the resolution of displaying the first non-gazing region through the at least one display unit or reduces the resolution of the first non-gazing region through the host and then outputs the frame to the at least one display unit to display the frame.

6. The display apparatus of claim 1, wherein the sensing unit of the host senses the first gaze position and the first distance through eyeball tracking technology.

7. The display apparatus of claim 1, wherein the first gaze range has a gaze radius and there is a proportional relationship between the gaze radius and the first distance.

8. A display apparatus, comprising:
a first display unit;
a second display unit; and
a host, cooperated with the first display unit and the second display unit, the host comprising:
a sensing unit, when the first display unit and the second display unit display a frame, the sensing unit sensing a gaze position on the frame which is gazed by an eye and a distance between the eye and the gaze position;
wherein if the gaze position is located on the first display unit, the display apparatus determines a gaze range on the first display unit corresponding the distance, divides the frame into a gaze region on the first display unit and a non-gaze region on the first display unit and the second display unit according the gaze position and the gaze range, and changes a display parameter of the gaze region on the first display unit or the non-gaze region on the first display unit and the second display unit to improve a contrast between the gaze region on the first display unit and the non-gaze region on the first display unit and the second display unit.

9. The display apparatus of claim 8, wherein if the gaze position is located on a first file displayed on the first display unit, the gaze region determined by the display apparatus covers the first file displayed on the first display unit and the non-gaze region determined by the display apparatus covers a second file displayed on the second display unit, the display apparatus changes a display parameter of the first file displayed on the first display unit or the second file displayed on the second display unit.

10. The display apparatus of claim 8, wherein the display apparatus reduces backlight brightness corresponding to the non-gaze region on the first display unit and the second display unit.

11. The display apparatus of claim 8, wherein the display apparatus reduces resolution corresponding to the non-gaze region on the first display unit and the second display unit.

12. The display apparatus of claim 11, wherein the display apparatus reduces the resolution of the non-gazing region on the first display unit and the second display unit through the first display unit and the second display unit or reduces the resolution of the non-gazing region on the first display unit and the second display through the host and then the host outputs the frame to the first display unit and the second display unit to display the frame.

13. The display apparatus of claim 8, wherein when the distance between the eye and the gaze position is changed from the distance to a changed distance, the display apparatus determines whether the distance and the changed distance are within the same distance interval.

14. The display apparatus of claim 13, wherein if a determination result of the display apparatus is YES, the display apparatus maintains the gaze range unchanged.

15. The display apparatus of claim 13, wherein if a determination result of the display apparatus is NO, the display apparatus determines a corresponding changed gaze range according to the changed distance, and divides the frame into a changed gaze region and a changed non-gaze region according to the gaze position and the changed gaze range and changes display parameters of the changed gaze region or the changed non-gaze region.

16. The display apparatus of claim 8, wherein the sensing unit of the host senses the gaze position and the distance through eyeball tracking technology.

17. The display apparatus of claim 8, wherein the gaze range has a gaze radius and there is a proportional relationship between the gaze radius and the distance.
